(19) United States
(12) Patent Application Publication
(10) Pub. No.: US 2003/0077049 A1
(43) Pub. Date: Apr. 24, 2003

(54) Method and apparatus for packaging optical-electronic components

(76) Inventors: Kirit S. Dharia, Thousand Oaks, CA (US); Robert Franks, Thousand Oaks, CA (US); Ivair Gontijo, Los Angeles, CA (US); Gary Lee Gutierrez, Newbury Park, CA (US); M.P. Ramachandra Panicker, Camarillo, CA (US); Ruai Yu, Newbury Park, CA (US)

Correspondence Address: Tejinder Singh, Newport Law Group, 5001 Birch, Newport Beach, CA, 92660, US

(21) Appl. No.: 10/038,039

(22) Filed: Oct. 19, 2001

(51) Int. Cl. G02B 6/42; G02B 6/36

(52) U.S. Cl. 385/88; 385/86

(57) ABSTRACT

A system and process is provided for packaging optical-electronic components used in fiber-optics networks. A top lid with an opening covers all the components of the optical-electronic package. A fiber boot with a groove is provided, wherein the opening in the top lid mates with the fiber boot groove. The fiber boot groove is located between plural shoulders. An optical fiber passes through an opening in the fiber boot and is firmly held within the fiber boot.

### BACKGROUND OF THE INVENTION

1. Field of the Invention

The present invention relates to semiconductor devices used in fiber optics networks and more particularly to packaging optical-electronic components used in such networks.

2. Background

Semiconductor devices are extensively used in high bandwidth fiber optics networks. FIG. 1 shows a top level block diagram of a typical fiber optics network 100, which includes a transmitter 100A that receives an electrical input (not shown) and converts it to an optical output 100B using a laser diode (not shown). Optical signal 100B is transmitted via optical fiber (not shown) and is received by optical amplifier 100C. Optical amplifier 100C amplifies optical signal 100B and the amplified signal 100D is transmitted to photodetector 100F, via filter 100E.

Typically, transmitter 100A or photodetector 100F, with other components, are assembled in packages and then installed in fiber optics network 100. A package with a laser diode is called the transmitter package or transmitter module, while a package with a photodetector is referred to as a receiver package or receiver module. The way the foregoing components are packaged plays a significant role in the overall performance of fiber optics network 100.

FIG. 2 shows a conventional packaging technique with a cross-sectional view of a receiver module 200, having photodetector 206 (same as photodetector 100F). Optical fiber 202 covered by fiber pipe 203 enters a sealing ring 204. Photodetector 206 is connected to transimpedance amplifier 207 via wire bond 209. Transimpedance amplifier 207 is connected to limiting amplifier 208 via wire bond 210, and limiting amplifier 208 is connected to electrical lead or connector 212 via wire bond 211. Photodetector 206, transimpedance amplifier 207 and limiting amplifier 208 are all placed on submount 205, which is mounted on base 201.

FIG. 3 shows another conventional packaging technique. This packaging technique may be used for laser diodes or photodetectors. Package 300, also referred as a “butterfly package”, includes a sealing ring 301 that is typically made of kovar and covers all the components of a transmitter and/or receiver module (not shown). Optical fiber 202, as shown in FIG. 1, enters sealing ring 301 through fiber pipe 302 and fiber boot 303. A stepped lid 304 covers sealing ring 301. Sealing ring 301 includes flange area 306 with opening 307 for positioning package 300 on a base (not shown). Leads' 305 are placed between sealing ring 301 and stepped lid 304.

The foregoing packaging techniques have various disadvantages. Firstly, the packaging requires numerous components, e.g., fiber pipe, fiber boot, sealing ring and a stepped lid etc. The greater the number of components, the higher the packaging cost.

Secondly, because leads' 305 are located between top lid 304 and sealing ring 301, a recess is required on a printed circuit board (“PC”) board (not shown) where module 300 is mounted in order to align the leads 305 to the PC board which increases the cost of the module.

Therefore, there is a need for a method and apparatus for improving the packaging of optical-electronic components used in fiber optics network without too many components.

### SUMMARY OF THE INVENTION

In accordance with one aspect of the present invention, there is provided a system for packaging optical-electronic components used in fiber-optics network. A top lid with an opening is provided, such that the top lid covers all the components of the optical-electronic package. A fiber boot with a groove is provided, wherein the opening in the top lid mates with the fiber boot groove. The fiber boot groove is located between plural shoulders. An optical fiber passes through an opening in the fiber boot and is firmly held within the fiber boot.

The fiber boot may be manufactured by injection molding of plastic or thermosetting of rubber. The fiber boot may also be manufactured from ceramic material or other insulating materials, metals and/or metal alloys.

In another aspect of the present invention, a method for packaging optical-electronic components used in fiber optics networks is provided. The process includes placing optical fiber in a fiber boot, wherein the fiber boot includes a groove between plural shoulder sections. The process also includes receiving a top lid, wherein the top lid is placed on the groove.

In one aspect of the present invention, no sealing ring, stepped lid or fiber pipe is required. Hence the overall cost of the package is reduced.

In another aspect of the present invention, the fiber boot not only prevents optical fiber from breaking, but also provides pull strength.

In yet another aspect of the present invention since the leads are surface mount, no recess is required on a printed circuit PC board.

This brief summary has been provided so that the nature of the invention may be understood quickly. A more complete understanding of the invention can be obtained by reference to the following detailed description of the preferred embodiments thereof, in connection with the attached drawings.

### BRIEF DESCRIPTION OF THE DRAWINGS

FIG. 1, as described above, is an illustration of a block diagram of a typical fiber optics network.

FIG. 2, as described above, is a cross-sectional view of an assembly showing conventional photodetector packaging techniques using metal housings and connectors.

FIG. 3, as described above, is a schematic illustration of a conventional “butterfly” packaging technique.

FIG. 4A shows an exploded view of an optical-electronic package, according to an aspect of the present invention.

FIG. 4B is a front view of a fiber boot shown in FIG. 4A, according to an aspect of the present invention.

FIG. 4C is the end view of the fiber boot in FIG. 4B, according to an aspect of the present invention.

FIG. 4D is the end view of a top lid shown in FIG. 4A.

FIG. 5 shows a process flow diagram according to an aspect of the present invention.

Features appearing in multiple figures with the same reference numeral are the same unless otherwise indicated.

### DETAILED DESCRIPTION OF THE PREFERRED EMBODIMENTS

In one aspect, the invention provides a packaging system that allows surface mounting of optical-electronic packages without using expensive components like sealing rings, fiber pipes and/or stepped lids. The system provides a ceramic lid with an opening that mates with a fiber boot having a groove and the ceramic lid is placed on the fiber boot groove. The fiber boot holds the optical fiber and no sealing ring; stepped lid or fiber pipe is required.

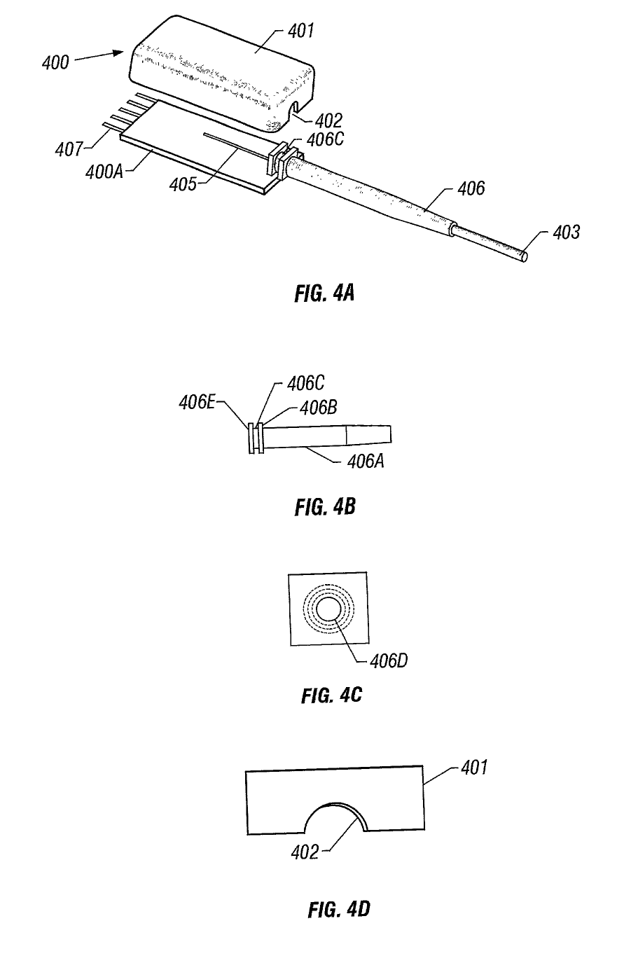

FIG. 4A shows an exploded view of the packaging system, according to one aspect of the present invention, for surface mounting an optical-electronic package without expensive sealing ring, fiber pipe or stepped lid.

Turning in detail to FIG. 4A is optical-electronic package 400 that may include a laser diode or a photodetector. Optical-electronic package 400 includes base 400A on which various components are mounted. Also included in optical-electronic package 400 is top lid 401, which is placed over base 400A and covers other components (e.g., laser diode or photodetector). Top lid 401 includes opening 402 that mates with fiber boot 406 according to an aspect of the present invention. Opening 402 is also shown in the end view of top lid 401 in FIG. 4D.

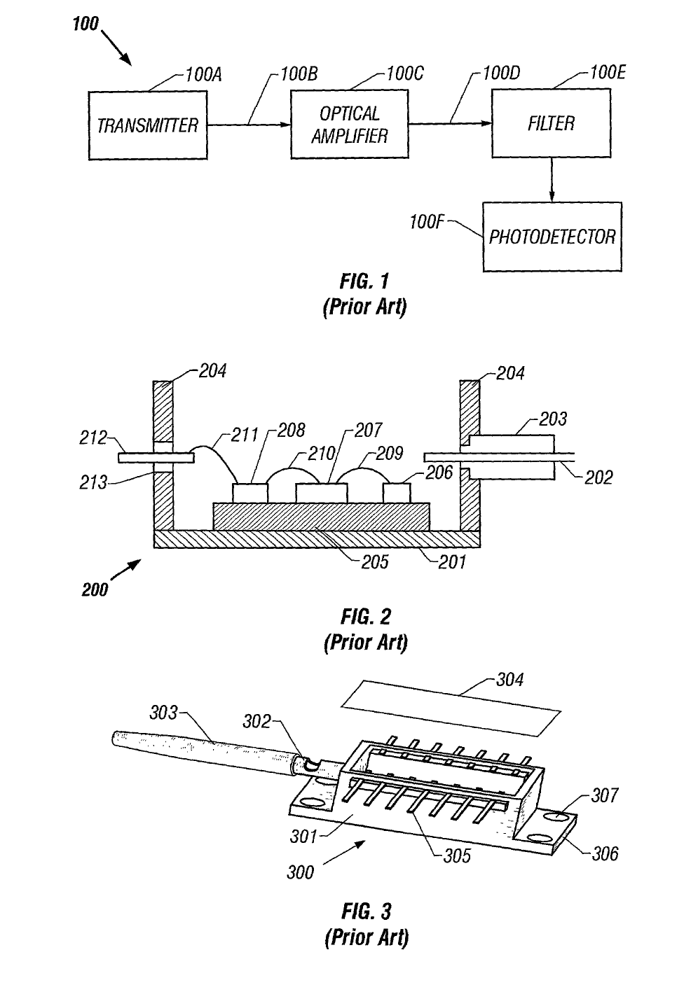

Optical fiber 405 passes through fiber boot 406 and is aligned with a photodetector (e.g. photodetector 206 of FIG. 1) or a laser diode (not shown). Epoxy or other means may be used to secure optical fiber 405 in fiber boot 406 after optical fiber 405 is aligned.

Fiber boot 406 includes groove 406C between shoulders 406B and 406E (shown in FIG. 4B). After optical fiber 405 is aligned and placed in fiber boot 406, top lid 401 is placed on base 400A and fiber boot groove 406C. Top lid 401 is placed between shoulders 406B and 406E. Epoxy or other means such as solder may be used to secure top lid 401 on base 400A and fiber 406. Since top lid 401 mates with fiber 406 and covers all the components, no sealing ring is required. Jacket 403 covers optical fiber 405 for protection.

FIG. 4B shows a front view of fiber boot 406. Fiber boot 406 includes length area 406A through which optical fiber 405 passes. FIG. 4B also shows groove 406C between 406B and 406E, which receives top lid 401.

FIG. 4C illustrates an end view of fiber boot 406 and shows opening 406D and face 406E. Optical fiber 405 with its jacket 403 enters optical-electronic package 400 through opening 406D.

Fiber boot 406 may be manufactured by injection molding thermo-plastic polymers, including without limitation, thermo-plastic elastomers. Fiber boot 406 may also be manufactured by thermo-setting rubber. It is noteworthy that the invention is not limited to a plastic or rubber fiber boot 406, and ceramic, metals, alloys or other materials may be used to produce fiber boot 406.

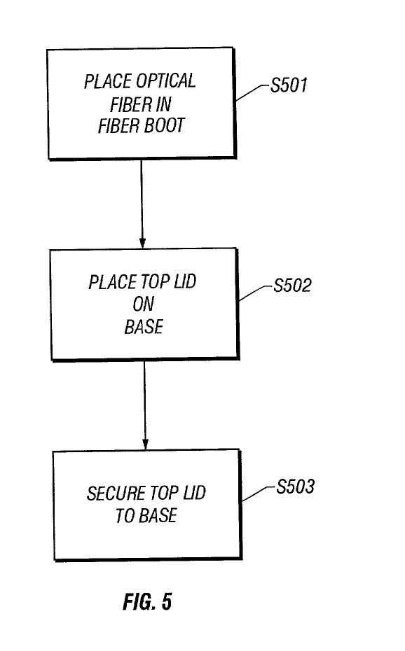

FIG. 5 is a flow diagram of process steps according to one aspect of the present invention for using fiber boot 406 such that no sealing ring, fiber pipe or stepped lid is required.

Turning in detail to FIG. 5, in step S501, optical fiber 405 is secured in fiber boot 406, after optical fiber 405 is aligned with respect to the other components, i.e. laser diode or photodetector. Epoxy or other material may be used to secure optical fiber 405 in fiber boot 406.

In step S502, top lid 401 is paced on base 400A such that top lid opening 402 mates with groove 406C of fiber boot 406.

In step S503, top lid 401 is secured on base 400A. Epoxy or other material may be used to secure top lid 401 on base 400A.

In one aspect of the present invention, no sealing ring, stepped lid or fiber pipe is required. Hence the overall cost of the package is reduced.

In another aspect of the present invention, the fiber boot not only prevents optical fiber breakage, but also provides pull strength.

In yet another aspect of the present invention since leads' 407 are surface mount, no recess is required to align the leads on a PC board.

While the present invention is described above with respect to what is currently considered its preferred embodiments, it is to be understood that the invention is not limited to that described above. To the contrary, the invention is intended to cover various modifications and equivalent arrangements within the spirit and scope of the appended claims.

What is claimed is:

1. A system for packaging optical-electronic components used in a fiber-optics network, comprising:
a top lid with an opening; and
a fiber boot with a groove, wherein the top lid is placed on the fiber boot groove.

2. The system of claim 1, wherein the fiber boot groove is located between plural shoulders.

3. The system of claim 1, wherein an optical fiber passes through an opening in the fiber boot.

4. The system of claim 4, wherein the optical fiber is held firmly in the fiber boot.

5. The system of claim 1, wherein the fiber boot is manufactured by injection molding.

6. The system of claim 1, wherein the fiber boot is manufactured by thermo-setting plastic.

7. The system of claim 1, wherein the fiber boot is manufactured from ceramic material.

8. The system of claim 1, wherein the fiber boot is manufactured from metal alloy.

9. The system of claim 1, wherein the fiber boot is manufactured from non-ceramic insulating material.

10. A fiber boot for holding optical fiber in a fiber optics network, comprising:
a groove between plural shoulders for receiving a top lid.

11. The fiber boot of claim 10 includes an opening for carrying the optical fiber.

12. The fiber boot of claim 10, wherein the optical fiber is held firmly in the fiber boot.

13. The fiber boot of claim 10, wherein the fiber boot is manufactured by injection molding.

14. The fiber boot of claim 10, wherein the fiber boot is manufactured from ceramic material.

15. The fiber boot of claim 10, wherein the fiber boot is manufactured by thermo-setting plastic.

16. The fiber boot of claim 10, wherein the fiber boot is manufactured from metal alloy.

17. The fiber boot of claim 10, wherein the fiber boot is manufactured from non-ceramic insulating material.

18. A method for packaging optical-electronic packages in fiber optics networks, comprising:
placing optical fiber in a fiber boot, wherein the fiber boot includes a groove between plural shoulder sections; and
receiving a top lid, wherein the top lid is placed on the groove.

19. The method of claim 18, wherein the optical fiber is held firmly in the fiber boot.

20. The method of claim 18, wherein the fiber boot is manufactured by injection molding.

21. The method of claim 18, wherein the fiber boot is manufactured from ceramic material.

22. The method of claim 18, wherein the fiber boot is manufactured by thermo-setting plastic.

23. The method of claim 18, wherein the fiber boot is manufactured from metal alloy.

24. The method of claim 18, wherein the fiber boot is manufactured from non-ceramic insulating material.
